(19) United States
(12) Patent Application Publication
(10) Pub. No.: US 2025/0314193 A1
(43) Pub. Date: Oct. 9, 2025

(54) INTERNAL COMBUSTION ENGINE

(71) Applicants: DEUTZ Aktiengesellschaft, Cologne (DE); Deere & Company, Moline, IL (US)

(72) Inventors: Daan KITZER, Köln (DE); Marco SLIWA, Siegburg (DE)

(21) Appl. No.: 19/170,442

(22) Filed: Apr. 4, 2025

(30) Foreign Application Priority Data
Apr. 9, 2024 (DE) 10 2024 109 830.9

(51) Int. Cl. F01P 3/18; F01P 3/02

(52) U.S. Cl. CPC F01P 3/18; F01P 3/02; F01P 2003/024; F01P 2070/52

(57) ABSTRACT

An internal combustion engine including a base engine; a water jacket which is formed in the base engine and through which a cooling fluid can flow, a recess in a wall of the base engine which extends into the water jacket, a heat exchanger which is arranged at least partially in the recess and through which a second fluid can flow, so that thermal energy can be exchanged between the cooling fluid and the second fluid, a heat exchanger cover, via which the heat exchanger is connected to a fluid circuit through which the second fluid can flow, the heat exchanger being fastened to the heat exchanger cover and the heat exchanger cover being fastened to the base engine, and a pin which positions the heat exchanger cover, the contact section and the base engine relative to one another.

### CROSS REFERENCE TO RELATED APPLICATION

This claims the benefit of German Patent Applications DE 10 2024 109 830.9, filed on Apr. 9, 2024 and which is hereby incorporated by reference herein.

### TECHNICAL FIELD

The present disclosure relates to an internal combustion engine which has a heat exchanger arranged in a water jacket.

### BACKGROUND

Heat exchangers are used in internal combustion engines to transfer thermal energy from one fluid circuit to another fluid circuit. For this purpose, internal combustion engines have a cast-in water jacket in the crankcase and/or cylinder head, for example, in which coolant circulates to cool the internal combustion engine. The heat exchanger can be inserted into this water jacket and connected to another fluid circuit, for example the oil circuit.

A combustion engine with a heat exchanger is known from DE 10 2019 006 664 A1. The heat exchanger is arranged in a pocket of a crankcase, which is part of the water jacket of the internal combustion engine. Inside the pocket, the crankcase has an oil inlet and an oil outlet, into each of which complementary sockets of the heat exchanger are inserted in order to connect it to the oil circuit. The heat exchanger is screwed onto the oil inlet and the oil outlet using screw plates. The pocket in the crankcase is closed by a heat exchanger cover that includes guide ribs. The guide ribs surround the heat exchanger together with cast ribs formed in the pocket, so that a small gap is formed between the heat exchanger on one side and the crankcase and heat exchanger cover on the other side in order to reduce the amount of fluid flowing past the heat exchanger.

DE 43 13 506 A1 describes an oil cooler in disk design with a disk pack through which air can flow and which is provided with an inlet and an outlet. The oil cooler is arranged in the longitudinal direction of the oil cooler in a recess in a housing, with sealing strips arranged between the sides of the disk pack and the opposite walls of the housing transverse to the longitudinal direction of the housing. The oil cooler has a cover that is screwed directly onto an outer surface of the housing.

### SUMMARY

The present disclosure describes an internal combustion engine with a heat exchanger which enables simple mounting of the heat exchanger in a housing of the internal combustion engine with a high position tolerance at the same time.

According to one aspect, an internal combustion engine is proposed, comprising:
a base engine; a water jacket that is formed in the base engine and through which a cooling fluid can flow, a recess in a wall of the base engine, which extends into the water jacket, a heat exchanger, which is arranged at least partially in the recess and through which a second fluid can flow, so that thermal energy can be exchanged between the cooling fluid and the second fluid, a heat exchanger cover, via which the heat exchanger is connected to a fluid circuit through which the second fluid can flow, wherein the heat exchanger is attached to the heat exchanger cover and the heat exchanger cover is attached to the base engine, and a pin that positions the three elements heat exchanger cover, contact section and base engine in relation to each other.

In a possible embodiment of the internal combustion engine, the heat exchanger cover may have a support surface. The heat exchanger can have a contact section that rests on the support surface of the heat exchanger cover. The contact section of the heat exchanger and the base engine can be arranged at a distance from each other. In this case, a gap is formed between the contact section of the heat exchanger and the base engine. In other words, the contact section of the heat exchanger and the base engine are arranged without contact to each other.

In a possible further embodiment, the base engine can have a mounting surface. The mounting surface can be flat and/or encircle the recess in the wall of the base engine. The heat exchanger cover can have a sealing section, wherein the sealing section of the heat exchanger cover rests on the mounting surface of the base engine. A contact area between the sealing section and the mounting surface can encircle the recess in the wall of the base engine.

The sealing section of the heat exchanger cover might comprise a sealing element which is in contact with the mounting surface of the base engine in the contact area, so that the recess in the wall of the base engine is encircled by the sealing element. In other words, the recess in the wall of the base engine is sealed off from the environment of the internal combustion engine by means of the sealing element.

In a possible further embodiment, a positioning hole can be provided in the base engine, in the contact section of the heat exchanger and in the heat exchanger cover. The pin can be arranged in the three positioning holes or extend through them. In particular, the pin can be arranged without play in one, two or three of the three positioning holes mentioned. The positioning holes can have different diameters. At least two of the three positioning holes can have a different diameter. The positioning holes of the base engine, the heat exchanger and the heat exchanger cover can be arranged coaxially on the base engine when the heat exchanger and heat exchanger cover are mounted.

In another possible embodiment, the pin can be non-detachably connected to at least one of the base engine, the heat exchanger and the heat exchanger cover, for example by gluing, welding or soldering. In other words, the pin can be connected to at least one of the base engine, the heat exchanger and the heat exchanger cover in a force-fit, form-fit or material-fit manner.

In another possible embodiment, the pin can be designed in the form of a cylindrical pin, a tapered pin, a grooved pin, a spring pin or a clamping bush.

In another possible embodiment, the pin can be designed as a dowel pin.

In another possible embodiment, the heat exchanger and the heat exchanger cover can be clamped together by a screw. The screw can extend through an opening in the heat exchanger into a mating thread in the heat exchanger cover. The screw can be arranged with radial play in the opening of the heat exchanger in relation to a longitudinal axis of the pin. In other words, the screw can be preloaded without transverse force and/or arranged within the opening of the heat exchanger without making contact with the heat exchanger.

In another possible embodiment, the heat exchanger cover and the base engine can be clamped together by a screw. The screw can extend through an opening in the heat exchanger cover into a mating thread in the base engine. The screw can be arranged with radial play in the opening of the heat exchanger cover in relation to a longitudinal axis of the pin. In other words, the screw can be preloaded without transverse force and/or arranged within the opening of the heat exchanger cover without making contact with the heat exchanger cover.

In a further possible embodiment, the heat exchanger cover can be designed as a cast part, in particular as a die-cast part.

### BRIEF SUMMARY OF THE DRAWINGS

An embodiment of the internal combustion engine is explained below with reference to the figure drawings. Herein

FIG. 1 is a partial side view of a crankcase of an internal combustion engine;

FIG. 2 is a sectional view of the internal combustion engine from FIG. 1 in sectional plane II-II;

FIG. 3 is a sectional view of the internal combustion engine from FIG. 1 in sectional plane III-III; and

FIG. 4 is a sectional view of the internal combustion engine in sectional plane IV-IV in FIG. 2.

### DETAILED DESCRIPTION

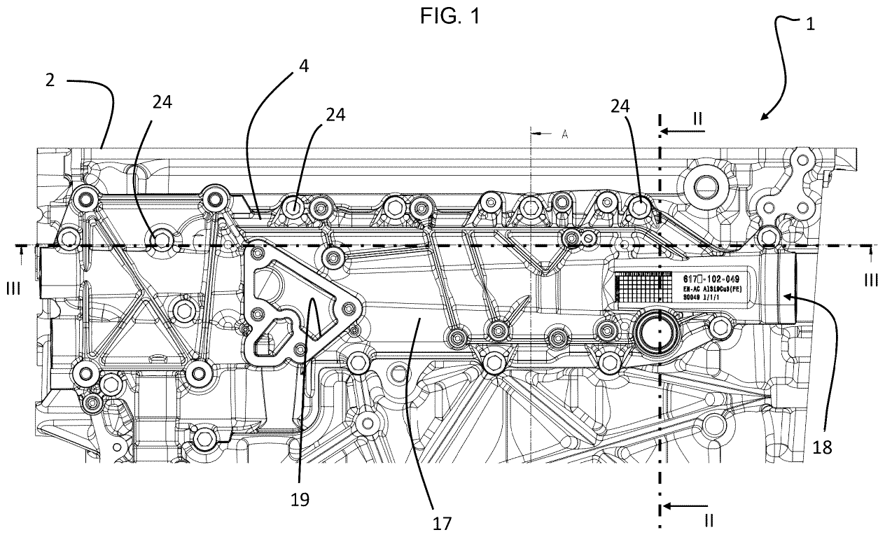

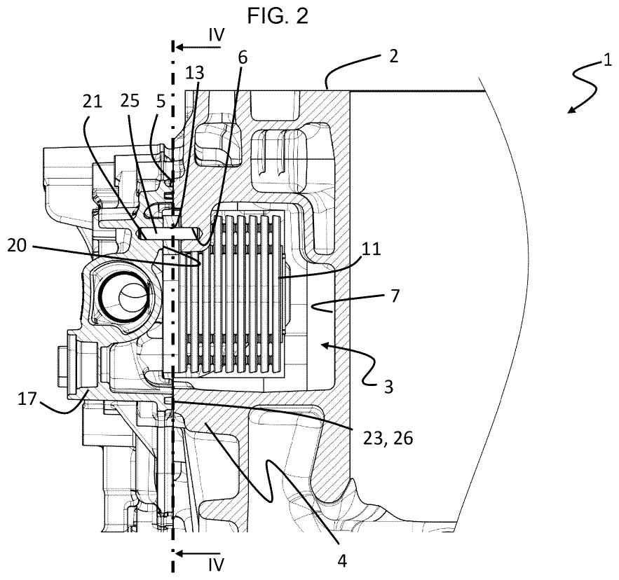

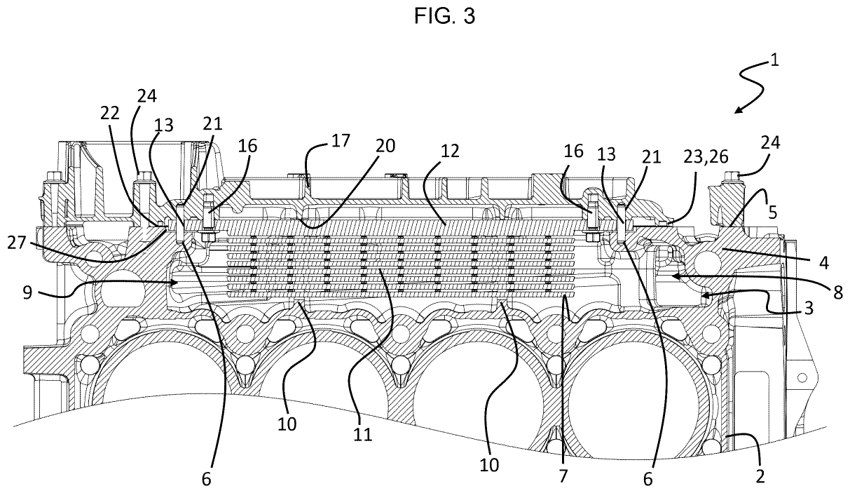

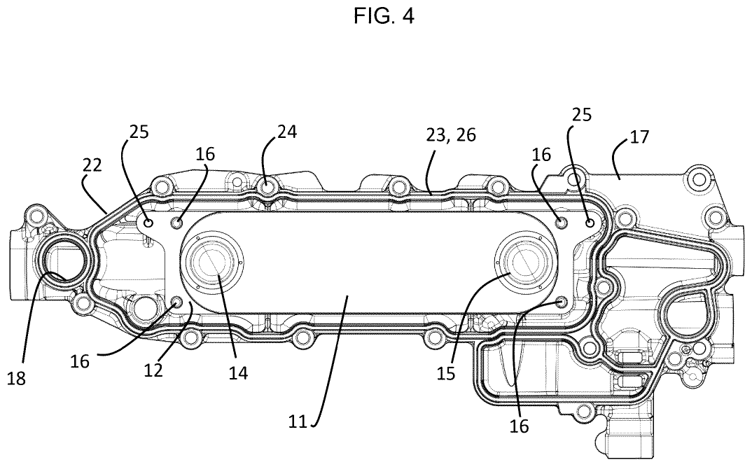

FIGS. 1 to 4, which are described together below, show parts of an internal combustion engine 1. For the sake of clarity, only the crankcase 2, the heat exchanger 11, the heat exchanger cover 17 and the elements used to connect the aforementioned components are shown in the Figures. In particular, the internal combustion engine 1 comprises a cylinder head, not shown, which is connected to the crankcase 2 in a known manner. The cylinder head and crankcase 2 together can also be referred to as the base engine.

A water jacket 3 is formed in the cylinder head and in the crankcase 2. A water jacket is a cavity in which cooling fluid can flow in order to cool the internal combustion engine 1. It will be appreciated by those skilled in the art that, as mentioned above, the choice of cooling fluid is not limited to water. In this respect, the water jacket can also be described as a cooling fluid jacket.

The crankcase 2 has a side wall 4 in which there is a recess 7 that extends into the water jacket 3. The area in which the water jacket 3 is open via the recess 7 towards an area surrounding the crankcase 2 can also be referred to as a pocket. The pocket is supplied with cooling fluid through an inlet 8. The cooling fluid can flow out of the pocket again via a drain 9.

A heat exchanger 11 is arranged in the recess 7 or in the pocket of the water jacket 3. Two guide ribs 10 are formed in the recess 7. The guide ribs 10 surround the heat exchanger 11 in the area of the recess 7, so that only a small gap is formed between the heat exchanger 11 and the crankcase 2. This means that only a small proportion of the cooling fluid flowing from the inlet 8 via the recess 7 towards the outlet 9 can flow past the heat exchanger 11, thereby increasing the effectiveness of the heat exchanger 11. In order to keep the gap around the heat exchanger 11 constant and to achieve the greatest possible effectiveness of the heat exchanger 11, the heat exchanger 11 must therefore be arranged with low tolerances in the recess 7.

The heat exchanger 11 is detachably connected to a heat exchanger cover 17. A contact section 12 of the heat exchanger 11 rests on a support surface 20 of the heat exchanger cover 17. For this purpose, one or more screws 16 extend through the contact section 12 into a mating thread of the heat exchanger cover 17. The contact section 12 of the heat exchanger 11 comprises one or more openings through each of which a screw 16 extends. In the present case, four screws 16 are provided, which extend through four openings in the contact section 12. In the area of the openings, the screws 16 are each arranged without contact with the heat exchanger cover 17. In other words, the screws 16 are arranged in the opening with radial play in relation to the longitudinal axis of the screws.

The clamping force of the screws 16 presses the contact section 12 of the heat exchanger 11 onto the support surface 20 of the heat exchanger cover 17 or clamps it against the latter.

For exact positioning of heat exchanger 11 and heat exchanger cover 17 relative to each other, the two parts are also positioned relative to each other via a first pin 25. In the present case, a second pin 25 is also provided. In the present case, the pin 25 is designed as a dowel pin, which is arranged in a hole 21 in the heat exchanger cover 17. The pin 25 also extends without play through a hole 13 in the contact section 12 of the heat exchanger 11. The pin 25 protrudes into a hole 6 of the crankcase 2 on the side of the contact section 12 facing away from the heat exchanger cover 17. The pin 25 is therefore also arranged without play in the hole 6. The three parts—crankcase 2, heat exchanger 11 and heat exchanger cover 17—are thus arranged with low tolerances to each other. This also minimizes deviations in the gap around the heat exchanger 11 in the water jacket and the associated leakage losses.

The pin 25 can be non-detachably connected to at least one of the crankcase 2, the contact section 12 of the heat exchanger 11 and the heat exchanger cover 17, for example by gluing, welding or soldering. In other words, the pin 25 can be connected to at least one of the crankcase 2, the contact section 12 of the heat exchanger 11 and the heat exchanger cover 17 in a force-fit, form-fit or material-fit manner.

The heat exchanger cover 17 comprises an annular or circumferential sealing section 22 which is in abutment with a mounting surface 5 of the crankcase 2. The hole 6 extends from this mounting surface 5 into the crankcase 2. The mounting surface 5 surrounds or encircles the recess 7. One or more screws 24 extend through a hole 21 in the heat exchanger cover 17 into a mating thread in the crankcase 2. The clamping force of the screws 24 clamps or presses the sealing section 22 of the heat exchanger cover 17 against the mounting surface 5 of the crankcase 2.

There is also a circumferential sealing recess 23 in the heat exchanger cover 17, which surrounds the recess 7. A sealing element 26 is inserted into the sealing recess 23, which is clamped between the heat exchanger cover 17 and the mounting surface 5 of the crankcase 2. The sealing element 26 seals the pocket from the surroundings of the crankcase 2.

The contact section 12 of the heat exchanger 11 is arranged without contact to the crankcase 2. A circumferential gap 27 is formed between the contact section 12 of the heat exchanger 11 and the crankcase 2.

In the present case, the heat exchanger 11 is designed as an oil cooler, which is connected to the oil circuit of the internal combustion engine 1 via an inlet socket 14 and an outlet socket 15. For this purpose, the inlet socket 14 projects into an inlet opening of the heat exchanger cover 17, which is concealed in the figures, and the outlet socket 15 projects into an outlet opening of the heat exchanger cover 17, which is concealed in the figures. The heat exchanger cover 17 has an inlet opening 18, which is connected to an oil source of the oil circuit, and an outlet opening, which is connected to an oil sink of the oil circuit.

### LIST OF REFERENCE SIGNS

1 Internal combustion engine
2 Crankcase
3 Water jacket
4 Wall
5 Mounting surface
6 Hole
7 Recess
8 Inlet
9 Outlet
10 Guide rib
11 Heat exchanger
12 Contact section
13 Aperture
14 Inlet socket
15 Outlet socket
16 Screw
17 Heat exchanger cover
18 Inlet opening
19 Outlet opening
20 Supporting surface
21 Hole
22 Sealing section
23 Circumferential sealing recess
24 Screw
25 Pin
26 Sealing element
27 Gap

What is claimed is:

1. An internal combustion engine comprising:
a base engine;
a water jacket formed in the base engine and configured for a cooling fluid to flow through;
a recess in a wall of the base engine, the recess extending into the water jacket, a heat exchanger arranged at least partially in the recess configured for a second fluid to flow through so that thermal energy is exchangeable between the cooling fluid and the second fluid; and
a heat exchanger cover, via which the heat exchanger is connected to a fluid circuit configured for the second fluid to flow through,
wherein the heat exchanger is attached to the heat exchanger cover and the heat exchanger cover is attached to the base engine, and
wherein the internal combustion engine further comprises a pin that positions the heat exchanger cover and the base engine in relation to each other.

2. The internal combustion engine according to claim 1,
wherein the heat exchanger cover has a support surface and
wherein the heat exchanger has a contact section which rests on the support surface of the heat exchanger cover, the pin positioning the heat exchanger cover and heat exchanger relative to one another.

3. The internal combustion engine according to claim 1,
wherein the base engine has a mounting surface,
wherein the heat exchanger cover has a sealing section, and
wherein the sealing section of the heat exchanger cover rests on the mounting surface of the base engine, so that a contact area between the sealing section and the mounting surface encloses the recess in the wall of the base engine.

4. The internal combustion engine according to claim 3, wherein the sealing section of the heat exchanger cover comprises a sealing element which is in contact with the mounting surface of the base engine in the contact area, so that the recess in the wall of the base engine is encircled by the sealing element.

5. The internal combustion engine according to claim 1,
wherein a respective positioning hole is provided in the base engine, in the contact section of the heat exchanger and in the heat exchanger cover, and
wherein the pin is arranged in the three positioning holes.

6. The internal combustion engine according to claim 5, wherein the pin is arranged without play in one, two or three of the three positioning holes.

7. The internal combustion engine according to claim 5, wherein at least two of the three positioning holes have a different diameter.

8. The internal combustion engine according to claim 1, wherein the pin is non-detachably connected to at least one of the base engine, the heat exchanger and the heat exchanger cover.

9. The internal combustion engine according to claim 1, wherein the pin is non-detachably connected to the at least one of the base engine, the heat exchanger and the heat exchanger cover by gluing, welding or soldering.

10. The internal combustion engine according to claim 1,
wherein the heat exchanger and the heat exchanger cover are clamped together via a screw, and
wherein the screw extends through an aperture in the heat exchanger into a mating thread in the heat exchanger cover, and the screw is arranged with radial play in the aperture.

11. The internal combustion engine according to claim 1,
wherein the heat exchanger cover and the base engine are clamped together via a screw, and
wherein the screw extends through an aperture in the heat exchanger cover into a mating thread in the base engine, and the screw is arranged with radial play in the aperture.

12. The internal combustion engine according to claim 2, wherein the contact section of the heat exchanger and the base engine are arranged at a distance from one another.

13. The internal combustion engine according to claim 1, wherein the pin is a cylindrical pin, a tapered pin, a grooved pin, a spring pin or a clamping bush.

14. The internal combustion engine according to claim 1, wherein the pin is a dowel pin.

15. The internal combustion engine according to claim 1, wherein the heat exchanger cover is a cast part.

16. The internal combustion engine according to claim 1, wherein the heat exchanger cover is a die-cast part.
